(19) United States
(12) Patent Application Publication
(10) Pub. No.: US 2011/0100158 A1
(43) Pub. Date: May 5, 2011

(54) SYSTEM FOR EFFECTIVE TRANSMISSION OF POWER

(76) Inventors: T P Jayachandran, Tiruppur (IN); R Loganathan, Chennai (IN)

(21) Appl. No.: 12/999,643

(22) PCT Filed: Apr. 6, 2009
(86) PCT No.: PCT/IN09/00223

§ 371 Date: Dec. 17, 2010

(30) Foreign Application Priority Data
Jun. 17, 2008 (IN) 1470/CHE/2008

(51) Int. Cl. F16H 1/00; F03G 7/10

(52) U.S. Cl. 74/640; 74/DIG. 9

(57) ABSTRACT

The present invention relates to a system for transmission of power comprising of a motor connected to a step down gear box connected to series of two step-up gear boxes through a coupling (C1), wherein said two step-up gear boxes are separated by another coupling (C2) such that the ratio of the radius of C1 to C1 is in the range of 1.4 to 1.9.

### TECHNICAL FIELD

The present invention relates to a system for effective transmission of power. More particularly, the present invention relates to transmission of power, without using an external source of energy for continuous running.

### BACKGROUND OF THE INVENTION

The transmission system known in the prior art comprises of a motor using a step up or a step down gear box to generate an output. Therefore, if a 1 HP of power is provided as an input to an engine, the present transmission system generates an output of 0.75 HP.

### OBJECT OF INVENTION

The object of the present invention is to provide an alternative substitute for conventional energy, which would generate its own power without using an external source of energy for continuous running.

### SUMMARY OF THE INVENTION

The present invention relates to a system for transmission of power comprising of a motor connected to a step down gear box connected to series of two step-up gear boxes through a coupling (C1), wherein said two step-up gear boxes are separated by another coupling (C2) such that the ratio of the radius of C2 to C1 is in the range of 1.4 to 1.9.

### DESCRIPTION OF THE INVENTION

The present invention will now be described with reference to the FIGURE accompanying the provisional specification, wherein the same numerals relate to the same parts and wherein:

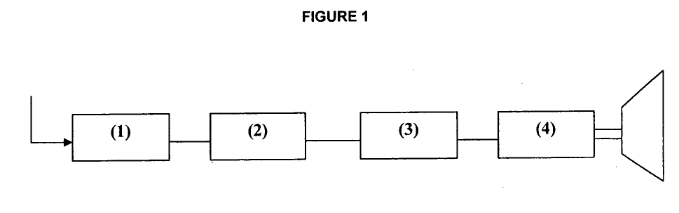

FIG. 1 shows the block diagram of the system.

A preferred embodiment of the present invention will be described with reference to the aforesaid drawing.

Referring to the FIG. 1, the present invention relates to a system for transmission of power. The system comprises of a motor or a gear box (1) connected to a step down gear box (2), which is further connected to two step-up gear boxes (3,4) to get an output. The system incorporates a pair of balancing couplings, which results into a controlled output.

The system for transmission of power comprises of a motor connected to a step down gear box connected to series of two step-up gear boxes through a coupling (C1), wherein said two step-up gear boxes are separated by another coupling (C2) such that the ratio of the radius of C2 to C1 is in the range of 1.4 to 1.9. Preferably, the ratio of the radius of C2 to C1 is 1.8.

The system as disclosed above can be connected in series with another system of the same kind to achieve maximum output.

The present invention is explained with the help of the examples:

### Example 1

An initial input of 1.5 HP of power is given to the motor, which produces an output of 3.5 Nm. A gear box (step-down) of 100:1 is connected to the motor, which results into an output of 315 Nm. further two 1:5 step-up gear boxes are connected in series, which incorporate a pair of balancing couplings. The output at the first setup-gear box is 70 Nm, whereas at the second step-up is 21.8 Nm. The final output is the system is about 2.29 HP.

Motor: 1.5 HP, 3000 RPM, 1200 Watts. Input Nm=3.5 Nm

### Gear: 100:1 Step Down Gear Box

### Input: 3.5 NM 3000 RPm Output=350 Nm, 30 RPm.

100:1 Gear EF %=90%, (Output: 315 Nm, 30 RPm).
350 Nm÷90%=315 NM
I) 1:5 Step-up Gear E.F %=90%, 1:4.5
   (1:5÷90%)=1:4.5 (315 Nm÷1:4.5)=70 Nm
(315 Nm 30 RPM Input), Output: (70 Nm, 150 RPM)
III 1:5 Step-up gear EF %=90% 1:5÷90%=1:4.5
1:4.5÷1.4Fr=1:3.2 (70 Nm÷1:3.2)=21.8
(70 NM input 150 R.P.M). (750 R.P.M. output 28 NM)

$$\begin{matrix}T 2 π N \\ 60\end{matrix} WATT \text{-} KW$$

$$T = 21.8 N m$$

$$2 π = 6.28$$

$$N = 750$$

$$\frac{21.8 \times 6.28 \times 750}{60} = \frac{102678}{60} = 1711.3 Watts output 2.29 hp$$

### Example 2

An initial input of 1.5 HP of power is given to the motor, which produces an output of 3.5 Nm. A gear box (step-down) of 100:1 is connected to the motor, which results into an output of 315 Nm. further two 1:5 step-up gear boxes are connected in series, which incorporate a pair of balancing couplings. The output at the first setup-gear box is 70 Nm, whereas at the second step-up is 23.3 Nm. The final output is the system is about 2.45 HP.

Motor: 1.5 HP, 3000 RPM, 1200 Watts. Input Nm=3.5 Nm

### Gear: 100:1 Step Down Gear Box

### Input: 3.5 NM 3000 RPm Output=350 Nm, 30 RPm.

100:1 Gear EF %=90%, (Output: 315 Nm, 30 RPm).
350 Nm÷90%=315 NM
II) 1:5 Step-up Gear E.F %=90%, 1:4.5
   (1:5÷90%)=1:4.5 (315 Nm÷1:4.5)=70 Nm
(315 Nm 30 RPM Input), Output: (70 Nm, 150 RPM)
III 1:5 Step-up gear EF %=90% 1:5÷90%=1:4.5
1:4.5÷1.5Fr=1:3 (70 Nm=1:3)=23.3
(70 NM input 150 R.P.M). (750 R.P.M. output 23.3 NM)

$$\frac{T 2 π N}{60} WATT \text{-} KW$$

$$T = 23.3 N m$$

$$2 π = 6.28$$

$$N = 750$$

$$\frac{23.3 \times 6.28 \times 750}{60} = \frac{109743}{60} = 1829.05 Watts output 2.45 Hp$$

### Example 3

An initial input of 1.5 HP of power is given to the motor, which produces an output of 3.5 Nm. A gear box (step-down) of 100:1 is connected to the motor, which results into an output of 315 Nm. further two 1:5 step-up gear boxes are connected in series, which incorporate a pair of balancing couplings. The output at the first setup-gear box is 70 Nm, whereas at the second step-up is 24.88 Nm. The final output is the system is about 2.6 HP.

Motor: 1.5 HP, 3000 RPM, 1200 Watts. Input Nm=3.5 Nm

### Gear 100:1 Step Down Gear Box

### Input: 3.5 NM 3000 RPm Output=350 Nm, 30 RPm.

100:1 Gear EF %=90%, (Output: 315 Nm, 30 RPm).
350 Nm÷90%=315 NM
III) 1:5 Step-up Gear E.F %=90%, 1:4.5
   (1:5÷90%)=1:4.5 (315 Nm÷1:4.5)=70 Nm
(315 Nm 30 RPM Input), Output: (70 Nm, 150 RPM)
III 1:5 Step-up gear EF %=90% 1:5÷90%=1:4.5
1:4.5÷1.6Fr=1:2.81 (70 Nm÷1:2.81)=24.88
(70 NM input 150 R.P.M). (750 R.P.M. output 24.88 NM)

$$\frac{T 2 π N}{60} WATT \text{-} KW$$

$$T = 24.88 N m$$

$$2 π = 6.28$$

$$N = 750$$

$$\frac{24.88 \times 6.28 \times 750}{60} = \frac{117184.8}{60} = 1953.08 Watts output 2.6 Hp$$

### Example 4

An initial input of 1.5 HP of power is given to the motor, which produces an output of 3.5 Nm. A gear box (step-down) of 100:1 is connected to the motor, which results into an output of 315 Nm. further two 1:5 step-up gear boxes are connected in series, which incorporate a pair of balancing couplings. The output at the first setup-gear box is 70 Nm, whereas at the second step-up is 26.5 Nm. The final output is the system is about 2.78 HP.

Motor: 1.5 HP, 3000 RPM, 1200 Watts. Input Nm=3.5 Nm

### Gear: 100:1 Step Down Gear Box

### Input: 3.5 NM 3000 RPm Output=350 Nm, 30 RPm.

100:1 Gear EF %=90%, (Output: 315 Nm, 30 RPm).
350 Nm÷90%=315 NM
IV) 1:5 Step-up Gear E.F %=90%, 1:4.5
   (1:5÷90%)=1:4.5 (315 Nm 1:4.5)=70 Nm
(315 Nm 30 RPM Input), Output: (70 Nm, 150 RPM)
III 1:5 Step-up gear EF %=90% 1:5÷90%=1:4.5
1:4.5÷1.7Fr=1:2.64 (70 Nm÷1:2.64)=26.5
(70 NM input 150 R.P.M). (750 R.P.M. output 26.5 NM)

$$\frac{T 2 π N}{60} WATT \text{-} KW$$

$$T = 26.5 N m$$

$$2 π = 6.28$$

$$N = 750$$

$$\frac{26.5 \times 6.28 \times 750}{60} = \frac{124815}{60} = 2080.25 Watts output 2.78 Hp$$

### Example 5

An initial input of 1.5 HP of power is given to the motor, which produces an output of 3.5 Nm. A gear box (step-down) of 100:1 is connected to the motor, which results into an output of 315 Nm. further two 1:5 step-up gear boxes are connected in series, which incorporate a pair of balancing couplings. The output at the first setup-gear box is 70 Nm, whereas at the second step-up is 28 Nm. The final output is the system is about 2.9 HP.

Motor: 1.5 HP, 3000 RPM, 1200 Watts. Input Nm=3.5 Nm

### Gear 100:1 Step Down Gear Box

### Input: 3.5 NM 3000 RPm Output=350 Nm, 30 RPm.

100:1 Gear EF %=90%, (Output: 315 Nm, 30 RPm).
350 Nm÷90%=315 NM
V) 1:5 Step-up Gear E.F %=90%, 1:4.5
   (1:5÷90%)=1:4.5 (315 Nm÷1:4.5)=70 Nm
(315 Nm 30 RPM Input), Output: (70 Nm, 150 RPM)
III 1:5 Step-up gear EF %=90% 1:5÷90%=1:4.5
1:4.5÷1.8Fr=1:2.5 (70 Nm÷1:2.5)=28
(70 NM input 150 R.P.M). (750 R.P.M. output 28 NM)

$$\frac{T 2 π N}{60} WATT \text{-} KW$$

$$T = 28 N m$$

$$2 π = 6.28$$

$$N = 750$$

$$\frac{28 \times 6.28 \times 750}{60} = \frac{131880}{60} = 2198 Watts output$$

### Example 6

An initial input of 1.5 HP of power is given to the motor, which produces an output of 3.5 Nm. A gear box (step-down) of 100:1 is connected to the motor, which results into an output of 315 Nm. further two 1:5 step-up gear boxes are connected in series, which incorporate a pair of balancing couplings. The output at the first setup-gear box is 70 Nm, whereas at the second step-up is 30.4 Nm. The final output is the system is about 3.1 HP.

Motor: 1.5 HP, 3000 RPM, 1200 Watts. Input Nm=3.5 Nm

### Gear: 100:1 Step Down Gear Box

### Input: 3.5 NM 3000 RPm Output=350 Nm, 30 RPm.

100:1 Gear EF %=90%, (Output: 315 Nm, 30 RPm).
350 Nm÷90%=315 NM
VI) 1:5 Step-up Gear E.F %=90%, 1:4.5
   (1:5÷90%)=1:4.5 (315 Nm÷1:4.5)=70 Nm
(315 Nm 30 RPM Input), Output: (70 Nm, 150 RPM)
III 1:5 Step-up gear EF %=90% 1:5÷90%=1:4.5
1:4.5÷1.9Fr=1:2.3 (70 Nm÷1:2.3)=30.4
(70 NM input 150 R.P.M). (750 R.P.M. output 30.4 NM)

$$\frac{T 2 π N}{60} WATT \text{-} KW$$

$$T = 30.4 N m$$

$$2 π = 6.28$$

$$N = 750$$

$$\frac{30.4 \times 6.28 \times 750}{60} = \frac{143184}{60} = 2386.4 Watts output 3.1$$

The description of the present invention has been presented for purposes of illustration and description, and is not intended to be exhaustive or limited to the invention in the form disclosed. Many modifications and variations will be apparent to those of ordinary skill in the art. The embodiment and examples were chosen and described in order to best explain the principles of the invention, the practical application, and to enable others of ordinary skill in the art to understand the invention for various embodiments with various modifications as are suited to the particular use contemplated. The above mentioned examples and variations can be done by altering the appropriate governing parameters.

### ADVANTAGES

1. The present invention involves an external source only at the initial start up for the battery for self propelling itself.
2. The system is a substitute for conventional energy.
3. It is pollution free

1. A system for transmission of power comprising of a motor connected to a step down gear box connected to series of two step-up gear boxes through a coupling (C1), wherein said two step-up gear boxes are separated by another coupling (C2) such that the ratio of the radius of C2 to C1 is in the range of 1.4 to 1.9.

2. A system for transmission of power as claimed in claim 1, wherein said ratio of the radius of C2 to C1 is 1.8.

3. A system using the system as claimed in the aforesaid claims in series to achieve maximum output.

4. A system for transmission of power as herein described with reference to the examples and drawings accompanying the specification.
